(19) United States
(12) Patent Application Publication
(10) Pub. No.: US 2012/0199653 A1
(43) Pub. Date: Aug. 9, 2012

(54) BIOMETRIC IDENTIFICATION SYSTEM

(75) Inventor: Richard Wenzel, Sterling, VA (US)

(73) Assignee: MMRB HOLDINGS LLC, Sterling, VA (US)

(21) Appl. No.: 13/502,072

(22) PCT Filed: Oct. 15, 2009
(86) PCT No.: PCT/US2009/060867

§ 371 Date: Apr. 23, 2012

(51) Int. Cl. G06K 5/00

(52) U.S. Cl. 235/382

(57) ABSTRACT

A system and method for locally and centrally identifying individuals based on a combination of biometric data and personal data. An identification document suitable for use in embodiments of such a system and method, and a combination document scanner and biometric data reader that enables and performs some or all of the identification functions such a system and method.

### BACKGROUND

1. Field of the Invention

This invention pertains generally to biometric identification systems and specifically to card-based biometric data storage systems that can be carried by individuals and verified against a biometric scan to confirm the identity of the carrier.

2. Description of Related Art

Identity verification and validation systems are widely used and relied on today for anything from finance to travel to law enforcement. Although seen as an advance in identity verification, biometric scanning and identification systems still suffer from many disadvantages.

One particular source of difficulty is in the particular biometric data being examined. Issues of reliability and accuracy with respect to scans of fingerprints, faces, and retinas limit the viability and usability of such systems. Fingerprints may be marred by scarring or injuries and facial and retinal scans require complex equipment and precise positioning on the part of the person being scanned.

Another source of difficulty is verifying the biometric data. Communication with a central or remote database system that stores the relevant identity information (and any associated data such as access level, financial records, criminal record, or citizenship) may be a time-consuming and data-intensive operation. This makes deployment of remote or portable biometric scanning devices challenging as their response times may be limited and impaired by their data transmission capability as well as overall system load (number of requests pending, etc).

It would be an advance in the art to provide a biometric identification system that resolves both of the above issues such that biometric data is reliable, not easily changed, and rapidly and accurately acquired, and such that biometric data may be validated quickly and efficiently such that database access requests are limited only to those instances where they are actually required.

### SUMMARY OF INVENTION

Embodiments of the present invention relate to a method of verifying the identity of a person carrying an identification card, such as, for example, a National Identity Card. Embodiments of an identification card may include a picture, name, and address of the rightful possessor of the card as well as a chip or memory portion that contains the picture, name, address, and biometric data of the rightful possessor.

Embodiments of an identification card may serve as a digital passport, with embodiments of a chip or memory portion storing information on travel visas, virtual customs/border stamps, and/or associated travel history.

Further embodiments of an identification card may serve as a medical or insurance card, with embodiments of a chip or memory portion storing health records, insurance information, allergies, medical history, and other relevant data required for situations such as trauma care or hospital admission.

Embodiments of the biometric data may include an iris scan. Further embodiments may supplement the iris scan with additional biometric data such as fingerprints or retinal scans. Yet further embodiments may include DNA information, dental records, and/or blood type.

Embodiments of verification methods may include using a card reader/iris scanner device that reads the identification card (including the memory portion) and performs a biometric scan of the person carrying the card. Such a device may provide immediate identity verification without having to communicate with a centralized database if the information printed on the card matched the information stored on the card and the stored biometric data matches the biometric scan performed during card reading.

Further embodiments of such card reader devices may include battery-powered, man-portable options for use by entities such as law enforcement or customs. Such devices may permit easy and immediate identification of individuals carrying false or invalid identification. Embodiments of card reader devices may also be configured with wired or wireless communication capabilities that allow them to access—either directly or via a communications network—a database or system of databases and perform a full identity verification.

Embodiments of databases may include a biometric database associated with a master database or one or more personal information databases such that once a biometric record of an individual is located their identity and relevant personal information may be readily retrieved.

Embodiments of such database searches may be manually initiated by users of an embodiment of a card reader device or may be automatically triggered when an identity verification procedure does not return a match between a card carrier and the data stored on the card.

Embodiments of an iris scanner may be included in stationary or portable card reader/iris scanner devices. In some embodiments, the scanner may be configured to scan both eyes of a subject simultaneously. In other embodiments, the scanner may be configured or otherwise adjusted for optical diffraction or distortion potentially caused by subjects wearing contact lenses, prescription glasses, sunglasses, or having their face covered, obscured, or otherwise behind a windshield, helmet visor, security screen, one-way mirror, or similar partially transparent barrier. Yet further embodiments may be configured to perform scanning of moving subjects. Further embodiments still may be configured to perform scanning at a variety of distances from the subject, including ranges of more than ten meters. Further embodiments still may be configured to recognize and identify prosthetic eyes or eye covers, or otherwise recognize and indicate an un-readable eye or iris.

Some embodiments of a scanner may employ coherent light sources such as lasers and/or be coupled with infra-red imaging systems to allow for iris scanning under a wide range of lighting and visibility conditions, including night-time, dusty or hazy environments, high-glare scenarios (such as through a car windshield or a motorcycle helmet visor or sun glasses or darkened glass during full sun or in company with a floodlight), and a range of other related or similar situations.

Further embodiments of a card reader/iris scanner device may be integrated into automated controlled-access systems such as building or border or airport security checkpoints. Embodiments of such systems may include a card reader/iris scanner as part of an access gate that authenticates biometric data of an individual against the data on a supplied card. Some embodiments configured for passport-style cards may also check or otherwise verify if an individual is authorized to enter a country, is wanted by the police, or is reporting an inconsistent or incorrect travel or visa history.

Embodiments of the technologies described herein may also include an identity verification system based on a personally-carried identity document such as the above-discussed identification card or digital passport, or a company-issued or government-issued identification document. Embodiments of such a document may include an image of a rightful possessor of said document, a name of the rightful possessor, a date of birth of the rightful possessor, and an address of the rightful possessor.

Embodiments of such an identification document may also include a data storage device having stored thereon computer-readable representations of the image, name, date of birth, and address of the rightful possessor and a computer-readable representation of biometric information associated with the rightful possessor. Embodiments of the biometric information may include an iris scan.

Embodiments of such a document may be configured to work in concert with an identity determination unit that includes an identity document reader, a biometric scanner, a display, a memory portion, a user input portion, and a transceiver or similar transmitter/receiver portion.

Embodiments of the transmitter/receiver portion may be configured to communicate with a database system that includes a master database containing records of all rightful possessors of personally-carried identity documents and a biometric information database containing biometric information of all rightful possessors of personally-carried identity documents, the biometric database being associated with said master database.

In an embodiment of the above-described system, the identity determination unit may read the data storage device with the identity document reader and copy the computer-readable representations from the data storage device to its internal memory.

The biometric scanner may perform a biometric scan of a current possessor of the identity document and compare the biometric scan to the biometric information stored in internal memory. As noted above, the biometric scan may be an iris scan.

In some embodiments, when the biometric scan comparison does not result in a match, the transceiver portion may communicate the biometric scan data to the biometric database. A database lookup process may then be carried out in the database system and a result sent back to the identity determination unit indicating a record of the identity of the current possessor or a notification that the current possessor is not listed in the master and/or biometric databases.

In some embodiments, the user input portion may be configured such that a user of the identity determination unit may manually initiate communication between the identity determination unit and the biometric database or the master database in order to retrieve data associated with a rightful possessor or a current biometric scan.

In further embodiments of such a system, the identity determination unit maybe connected to or integrated with an access control gate such that when the biometric scan comparison does not result in a match, the scanned individual is not permitted to pass through the gate.

In yet further embodiments, the identity document reader may read the identity document and compare the information read from the identity document to the information in the memory portion. In some variations such embodiments, when either the biometric scan comparison or the identity document comparison do not result in a match, a database lookup may be initiated and, in access gate embodiments, the scanned person may be blocked from passing through the gate.

Embodiments of an identity determination unit in accordance with the present disclosure may include an iris scanner that scans at least one iris of an individual and an identity document reader that reads a personal identity document according to one of the above-discussed embodiments. Embodiments of an identity document designed to operate in concert with such an identity determination unit may have a computer-readable data storage device embedded therein, with the data storage device containing at least an iris scan of a rightful possessor of the document.

Embodiments of an identity determination unit may further include a data comparison unit that compares the iris scan of the individual against an iris scan read from the data storage device, a display that displays the personal information read from the data storage device, a memory unit that provides local data storage capacity, a data transmitter and receiver portion that communicates with one or more database systems, the database systems containing personal information and biometric information records associated with individuals who possess personal identity documents, a display portion that allows an operator view information read from the personal identity document; and an operator interface that allows a device operator to input data and commands to the determination unit. In some embodiments, data transmission and reception may also be encoded or encrypted with a data encoding unit. In further embodiments, encrypted or encoded data received by a receiver may be decrypted or decoded with a data decoding unit.

In further embodiments of an identity determination unit, the unit may be man-portable and configured to run on regular or rechargeable batteries. In some such embodiments, the data transmitter and receiver portion may be a wireless communication device such as a radio or cellular data transmission and reception unit. In yet other embodiments, the transmitter and receiver portion may be configured for satellite communications or line-of-sight optical communication.

In yet further embodiments, the operator interface may allow the operator to manually initiate communication with at least one database system and input search criteria acquired from the iris scan, the data storage device, or through manual operator input.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF DRAWINGS

The present invention will become more fully understood from the detailed description given hereinbelow and the accompanying drawings which are given by way of illustration only, and thus are not limitative of the present invention, and wherein

FIG. 1 a shows an embodiment of an identification document having biometric data stored thereon;

FIG. 1b shows alternate embodiments an identification document having biometric data stored thereon;

FIG. 2 shows an embodiment of a database system that associates biometric data with other personal information databases and systems;

FIG. 3 shows an embodiment of an identification document reader and biometric scanner;

FIG. 4a shows an embodiment of an identity verification process that allows for both local and central identity verification; and

FIG. 4b shows another embodiment of an identity verification process that allows for both local and central identity verification.

The drawings will be described in detail in the course of the detailed description of the invention.

### DETAILED DESCRIPTION OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

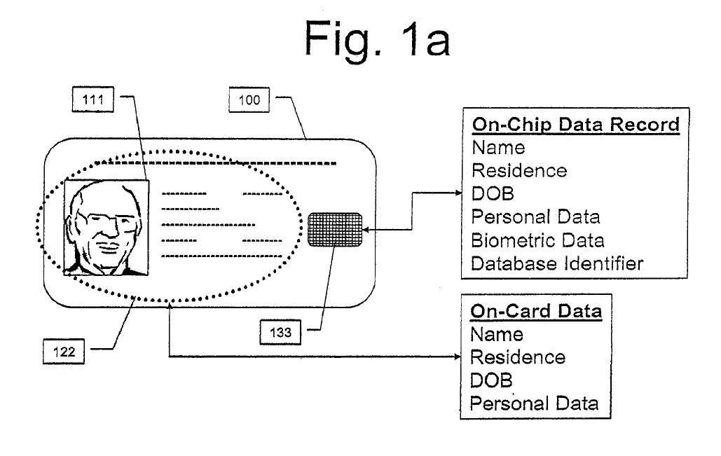

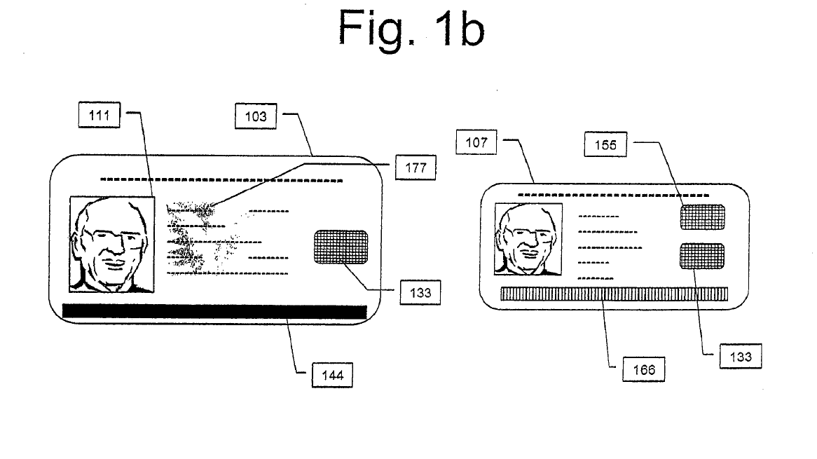

One aspect of an identity verification solution is a document, such as an identity card, to be carried by persons as proof of identification. Such a card may have a wide range of data printed or embedded thereon, including biometric information about the rightful possessor of the card. An embodiment of such a card is depicted in FIG. 1a.

An embodiment of such a card 100 may include an image of the rightful possessor of the card 111, personal data printed on the face of the card 122, and an embedded data storage device, such as a memory chip, 133 that stores personal and biometric data about the rightful possessor of the card. Embodiments of personal data 122 may include the rightful possessor's name, address, date of birth, residence, citizenship, height, weight, eye color, hair color, and other similar pieces of information.

Embodiments of a data storage device 133 may include a memory chip, an optically-readable storage medium, a printed bar code, or some combination thereof. The data storage device 133, as well as the overall card 100, may also be equipped with anti-tamper technologies that destroy data or provide clear visual indicators of attempts to alter the card or the storage device.

Embodiments of a data storage device 133 may store the rightful possessor's name, address, date of birth, residence, citizenship, height, weight, eye color, hair color, address history, criminal record, date of last data access attempt, date of card issue, and biometric data acquired from the rightful possessor. Embodiments of biometric data preferably include an iris scan. The iris scan is preferred because a human iris attains its final size and configuration in early childhood and does not subsequently change unless a persons eye becomes damaged. Whereas individuals may routinely cut and burn fingers, leading to potentially inaccurate fingerprints due to scarring, physical eye damage of the type required to alter an iris scan is much more rare and unlikely.

In some embodiments, the biometric data may include scans of both irises of a rightful possessor of an identity card. Such embodiments may further reduce potential issues associated with traumatic eye damage to a user as scans of both irises will be on record. Such embodiments also provide improved security and verification capability because an iris scan of a person's left eye will be different from the iris scan of their right eye. Individuals seeking to employ false or altered identification cards will therefore be required to have iris scans of two matching eyes instead of simply duplicating the same iris scan twice. Embodiments may also identify each scan as either a left scan or a right scan, allowing for further levels of verification and security.

Embodiments of the data storage device 133 may also include multiple data storage devices combined into a single component or distributed throughout a card or other identification document. Such a solution may allow for redundant storage of data in multiple locations on the card, such as having a memory chip and a magnetic strip with matching serial numbers. Such solutions may further improve and enhance the integrity of the card and make it even more difficult to replicate. Such embodiments are depicted in FIG. 1b.

In one alternate embodiment of an identification document 103, the document may also function as a virtual passport or real national identification device. In such an embodiment, in addition to the data storage device 133, embodiments of such a document may be equipped with a holographic security device 177 that serves to visually authenticate the document and may also store optically-encoded information associated with a person's citizenship, immigration status, or legal status (e.g. identifying the person as a minor). Embodiments may also be equipped with a magnetically or optically readable data stripe 144 that may store similar information and/or a document serial number or individual national identification number (such as a taxpayer ID). Embodiments of such a data stripe may also store the basic personal information of an individual in an encoded or encrypted format and/or information associated with the date and location of issue of the document. Such information may be used for identity verification, identity document tracking, and tamper/forgery identification.

In yet another alternate embodiment 107, the identification document may be equipped with a bar-code 166 and/or a secondary data storage device 155. Embodiments of such an identification document may have a first data storage device 133 dedicated to biometric and biological or medical-related data such as blood type, health records, a record of a DNA sample, known allergies, medical history, insurance information, and other relevant data required for scenarios such as hospital treatment, trauma care, or additional identity verification.. Embodiments of a second data storage device 155 may contain information related to visa or travel history, records of entries and exits from countries (i.e. virtual passport stamps), citizenship status, relevant law enforcement data (restrictions on driving, license issue date, etc.) and/or relevant personal data (address, marital status, birthplace, birth date, etc.).

Alternate embodiments may also include a small-scale RAID-type memory system whereby multiple memory devices are “striped” such that they contain redundant data to prevent or mitigate data loss in the event of physical damage to the identification document. Yet further embodiments may include options such as a holographic cover or insert having an image of the user's iris scan stored therein. Such an embodiment may allow for yet a further layer of security and tamper-resistance by requiring that the hologram, the data stored on the data storage device, and a real-time iris scan of the card carrier all match in order to verify identity. In yet further embodiments, the hologram itself may be the data storage device 133 or a portion thereof.

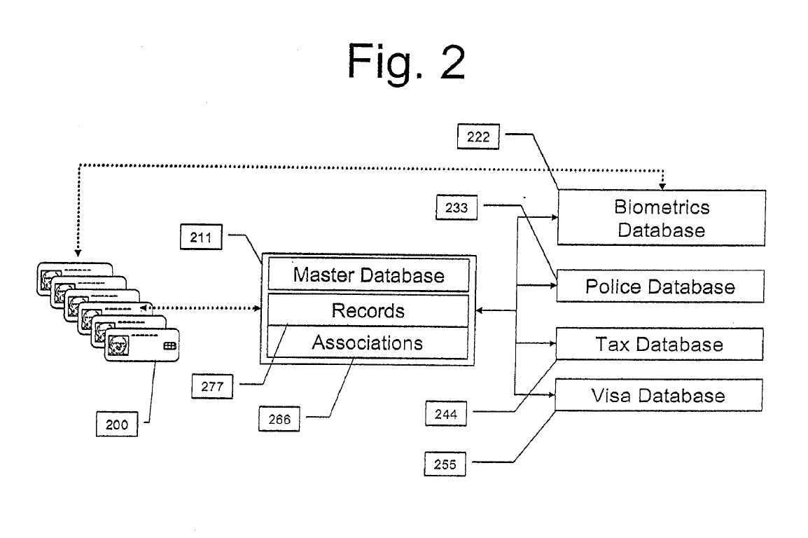

In one embodiment of a personal data storage and identification system, a card or identification document (such as a passport) may be issued to many individuals. The personal and biometric data of each individual may then be stored in one or more databases, which may themselves connect to yet more databases to allow a broad range of recordkeeping and data association based on an individual's personal and biometric data. An embodiment of such a system is depicted in FIG. 2.

The issued identification documents 200 are each associated with a record in a master database 211 and a biometric database 222. An embodiment of a master database 211 may include personal data records 277 and association records 266 for individual users. Embodiments of personal data records 277 may include basic information such as name, address, date of birth, citizenship/nationality, taxpayer identification number, residence, and similar related information. Embodiments of association records may include database record keys that allow a personal data record to be associated with one or more entries in a police or criminal record database, 233, a tax or property records database 244, or a visa/travel database 255. Embodiments of association records may also preferably include record keys that associated a personal data record with a biometrics database 222.

Embodiments of a biometrics database 222 may include a database of iris scans. Each record in such a biometrics database may be a single iris scan or may contain iris scans for both eyes of an individual. Further embodiments of a biometrics database 222 may also contain additional data such as one or more fingerprints, a DNA record, a retinal scan, blood type, known chronic medical conditions, dental records, eye color, hair color, hair type (straight, curly, wavy, etc.), ethnic classification, and a range of other visible or measurable biological characteristics. The biometrics database also preferably has an association record for each biometric data record that connects the biometric data record to a record in the master database.

In yet further embodiments, there may be overlap between data in a master record and a biometric record, or readily visible biometric-type data (such as eye or hair color) may be included in a master database record. In further embodiments still, there may be no master database record and instead the biometrics database 222 serves as a central association repository for connection and communication with other personal information databases such as tax and police database systems.

Embodiments of biometrics database records may be initially populated when an identification card is issued to an individual. Such an event may occur when a person reaches an age of military service eligibility, requests a drivers license, applies for a passport (or has a passport requested on their behalf), or is registered by a government or associated agency as a current or future taxpayer. In some embodiments, creation and issuance of such identification cards may be associated with a medical visit where an initial amount of biometric data is collected at one time. Such data may include iris scans, blood type, DNA sample, fingerprints, retinal scan, and/or currently known chronic medical conditions.

In embodiments associated with military service, the creation and issuance of such a card may be part of military enlistment or draft registration. In yet further embodiments, individuals may simply be required to submit iris scans at the point of card creation and issuance, with other necessary or associated information being accessed or acquired from already existing data sources such as medical history or police databases.

In one particular embodiment, an individual may be required to come to an issuing office, such as a public safety office, and have their irises scanned. Such an office may also provide same-visit identification card generation or may subsequently mail a completed identification card to the individual once their iris scans are uploaded to a biometrics database 222 and associated with a master record 277 or other database records as necessary. The complexity and comprehensiveness of an identification card 200 and its underlying data associations with various databases may determine whether an issuing office may create and dispense identification cards on a same-visit basis.

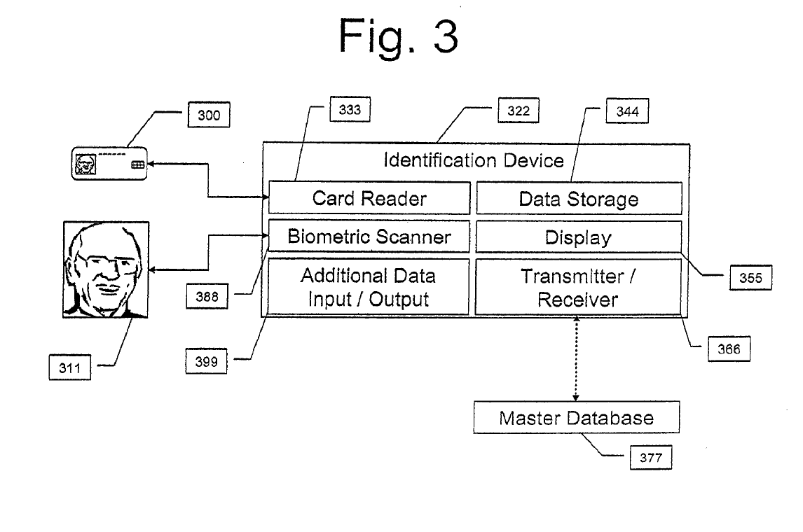

Once an identification card has been issued, an individual may be expected to present such a card for identification purposes. Associated with such a card there may therefore be one or more card reader devices used by airports, railways, seaports, customs officials, immigration agencies, law enforcement personnel, financial institutions, employers, and a whole host of other public or private entities wishing to confirm or otherwise validate the identity of an individual. An embodiment of such a reader device is depicted in FIG. 3.

An individual 311 presenting an identification card of the type described herein 300 may be required to insert it into or otherwise make the card accessible to a card reader 333 component of the identification device 322. The card reader component 333 may read some or all of the data included on the card 300, including any material printed on the card (including a picture of the rightful possessor) as well as any data contained in a data storage device, hologram sticker, magnetic stripe, bar code, or any other data storage medium included in the card.

Embodiments of a card reader component 333 may include a reception slot for card insertion, a card-swipe reader for reading a magnetic strip, electrical contacts for interfacing with a memory chip, an optical reader for scanning the card and any optically accessible data stored thereon, an antenna for radio-frequency (RF) based interrogation of a transponder-type component embedded in the card, and/or a power source for activating otherwise passive electrical components or signal pathways in the card to facilitate data output.

Embodiments of an identification device 322 may also include one or more data storage areas 344 that store personal and/or biometric information read by the card reader 333 as well as other data acquired or received by the identification device 322. Such data may include an operating system, various program or operation profiles, local lists of particular individuals being sought for questioning or otherwise of interest to the entity operating the identification device, results of internal calculations or comparisons performed by the identification device 322, indications of device or data status, and any other applicable or necessary information the device 322 or an operator thereof may require.

Embodiments of an identification device 322 may also be equipped with a display 355 that displays information such as the biometric and personal data read from a card to an operator of the device. Depending on the particular device embodiment, the device operator may be a third party or may be the possessor of the card. The display 355 may also provide status indications, indicate available data processing options, and indicate or otherwise signal deficiencies or problems with the card data read or with comparisons between the card data and other data acquired by the identification device 322. Embodiments of the display may be monochrome or color, and may incorporate touch-sensitive technology such that the display may also serve as an operator interface point. Display types and sizes may vary depending on the intended deployment environment of the device, with portable embodiments having smaller, more rugged display portions intended to be exposed to harsher conditions and use than stationary embodiments disposed at indoor access points such as airport terminals, border crossings, customs/immigration stations, rail terminals, or building lobbies.

Embodiments of an identification device 322 may also preferably be equipped with one or more biometric scanning components 388. For embodiments of cards bearing iris scan data, an identification device is preferably equipped with an iris scanner as a biometric scanner 388. Such an iris scanner may be configured to scan one eye at a time or scan both eyes of a card possessor simultaneously. Embodiments of an identification device 322 equipped with an iris scanner 388 may be configured to compare the results of the iris scan against the iris scan data read from the identification card and thereby determine if the possessor of the card is the rightful possessor of the card or is using a forged or stolen card. Such an identification process allows for a robust and reliable identification of an individual without requiring that the identification device communicate with an underlying or associated database system. Those individuals whose iris scans match the iris scans stored on their identification card may, with a fairly high degree of confidence, be presumed to be the rightful possessors of their identification cards.

In embodiments where further levels of security or validation may be required, an identification device may be equipped with multiple biometric scanning devices. One embodiment may combine a vital sign indicator such as an optical pulse oximeter with an iris scanner to ensure that the iris being scanned is actually composed of living, oxygenated muscle and not a fabrication or otherwise either non-organic or non-living.

Embodiments of an iris scanner may be configured with a gyroscopic stabilizer or with a similar compensation or motion adjustment device to allow for scanning of non-stationary subjects or to allow for effective scanning with a hand-held device that may be moved or otherwise jostled during scanning. Embodiments of an iris scanner may be configured to compensate for a wide range of intervening materials that may make an iris difficult to scan or read. Embodiments may be configured with some level of coherent light (laser) or infra-red illumination to compensate for glare, optical distortion, diffraction, or visual-spectrum filtering caused by things such as subjects wearing contact lenses, prescription glasses, sunglasses, motorcycle helmets with visors, mirrored glasses (or visors) or subjects being positioned behind a windshield, security screen, one-way glass, or similar fully or partially transparent barriers.

Embodiments of an iris scanner may be further configured with coherent light or infra-red illumination capability to compensate for a wide range of lighting and visibility conditions, such as night-time use, operation in exceedingly dusty or hazy visibility conditions, high-glare scenarios (such as full sun or floodlights on a car windshield or mirrored sunglasses), and other difficult visibility situations.

Further embodiments may be configured to identify potential drug use by a subject based on a state or iris contraction or dilation or configured to identify prosthetic eyes or eye covers. One such embodiment may take an iris scan, subject a user to a bright flash of light, and immediately take another scan. Lack of change in pupil diameter may be an indication of a subject in an intoxicated state or of one using an ocular prosthesis (such as a false eye or a contact lens with a false iris pattern on it) in such a scenario.

Yet further embodiments may be configured to perform scanning at ranges in excess of ten meters through the use of technologies such as eye-safe coherent light. Such iris scanners may allow for fast scanning of a subject's iris under a broad range of lighting conditions and at distances that would potentially make an iris scan not intrusive or otherwise disruptive of a subject's other actions.

Embodiments of an identification device may also include an additional data input/output portion 399 such as a keyboard or buttons or a touch-screen to allow a device operator to select various processing steps or options. In an embodiment situated at an airport, for instance, a device operator may be required to input a pass-phrase or PIN number as part of an identification or authorization sequence. In an embodiment configured for law-enforcement use, a police officer may wish to selectively view portions of an individual's card-based data for questioning purposes or may wish to manually initiate a full database search regardless of a match between a user's iris scan and the iris scan data on their card.

For embodiments suited for law enforcement or similar applications, it may be preferable to have a compact, man-portable version of an identification device. Such a device may be battery operated and configured for wireless communication. In such an embodiment a transmitter/receiver portion 366 of the device 322 may be a cellular modem or similar wireless communication device that may connect either directly or via a telecommunications network to a master database 377 or one of several other databases such as a police or biometric database.

For embodiments suited for use in airports, train terminals, border crossings, seaports, secure building access points or other similar controlled-access areas or transit points, portability may be less important and a transmitter/receiver portion 366 may be a wired connection either directly to a database or to a private or public communications network. Embodiments of an identification device may be incorporated or integrated into access control devices such as automated gates or turnstiles at building entrances, airports, rail stations, seaports, and/or at customs/border control locations.

Embodiments of a transmitter/receiver portion 366 may be configured for encrypted communication. Any available form of radio or cellular data encryption may be employed for added security and protection of the information being transmitted. Encryption schemes may be as complicated or as simple as required based on the location of the identification device and the security of its communication network. Devices transmitting data over publicly-accessible media, such as telephone lines, cellular communication frequencies, or public ethernet or fiber networks, may require stronger data encryption. Embodiments of such devices may have an encoder/decoder portion (not shown) integrated into the transmitter/receiver portion or as a separate sub-module. In some embodiments, the encoder/decoder may be selectively activated by a device operator or based on a detected communication network type.

Embodiments of an identification device may be configured to automatically contact an identity database when there is a mismatch between a biometric scan and the biometric data on an identification card, or when a biometric scan is performed without reading an associated identification card. By avoiding the requirement of a database search in all instances, power consumption of the identification device is reduced, identification times are decreased, and overall load on the associated identity databases is also decreased, making the whole system operate more quickly and efficiently. Such advantages are useful both to identification device operators and individuals being identified as the process may be more streamlined, thereby allowing individuals with valid credentials to be quickly identified and cleared as valid while those individuals with invalid credentials may be dealt with at greater length on an individual basis without a significant increase in either personnel or technological resource requirements.

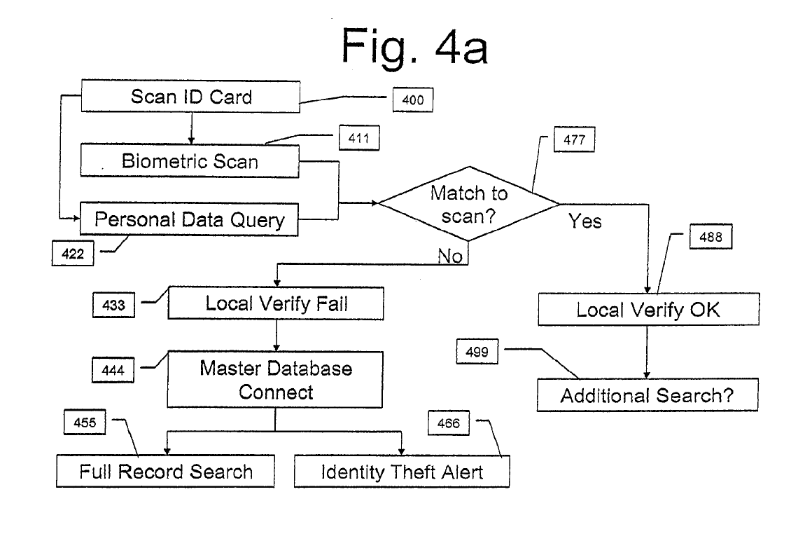

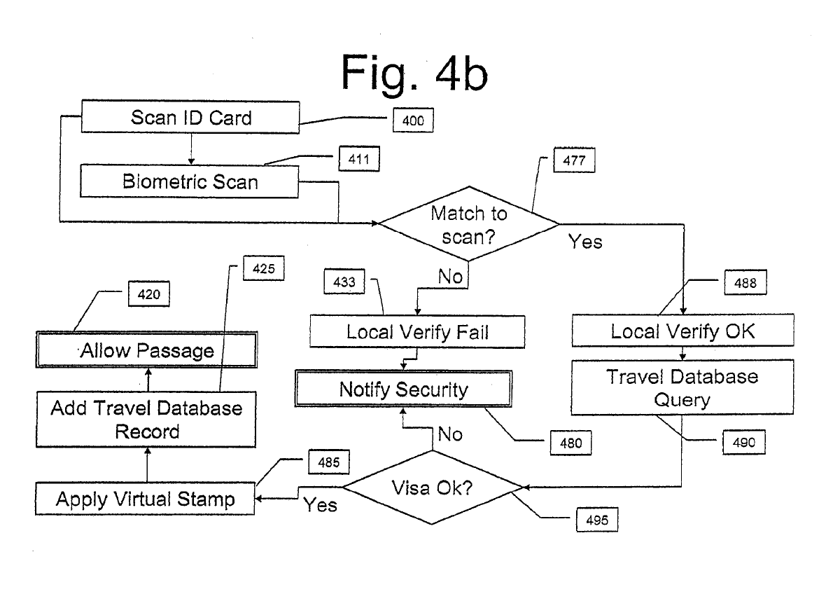

An embodiment of an identification process using an embodiment of an identification card and identification device system is depicted in FIG. 4a. In the embodiment depicted, the identity verification process begins with scanning an identity document 400 of a type discussed herein. Afterwards or concurrently with a document scan, a biometric scan 411 may be conducted to acquire biometric data, such as an iris scan, from the possessor of the identification document. A personal data query 422 may also be initiated, requesting the possessor of the identification document to verify personal information such as name, address, date of birth, residence, tax identification number, or citizenship.

Embodiments of a personal data query 422 may be automated via an interface on an identification device, or may be part of a manual, interactive process initiated by an operator of an identification device, such as a law enforcement officer or bank official asking someone to verify their personal data as part of an identification or authentication process.

Embodiments of a biometric scan 411 may include an iris scan, or may include an iris scan and a vital signs scan to verity that the iris being scanned belongs to either a living person or not, as appropriate for the particular purpose of the scan. Embodiments of a biometric scan may also include secondary biometric indicators such as fingerprints or retinal scans. Embodiments of an iris scan may require only a single iris scan or may require both eyes of an individual to be scanned. In some embodiments, both eyes may be scanned at the same time or each eye may be scanned individually. Yet further embodiments may integrate iris scanning into an overall image capture process whereby an individual's entire face is quickly scanned and then systematically processed for iris scan data, face recognition, and other biometric indicators.

Embodiments of an identification process may also be conducted without scanning an identification document, but such embodiments will necessarily require communication with a biometric database to establish the identity of the individual being scanned.

After scanning an iris of an individual and reading his identification document, and, in some instances, requesting the individual to provide personal information, the information is all compared and evaluated to determine if the biometric scan and provided personal information match 477 those read from the identification document. In some embodiments, when all the information matches 488, an identity of the individual scanned is determined to be initially valid. In some embodiments, an operator of an identification device may, at this point, opt to nonetheless contact a central database 499 for a full or partial search of the individual's personal and related information. In some embodiments, even if local verification produces a valid result 488, the individual may still be wanted for questioning or otherwise of interest to the party verifying his identity, in which case a further search may be initiated 499. In other embodiments, a local validation of an individual's identity is sufficient validation and the individual may then proceed to whatever activity required them to validate their identity (i.e. boarding a plane, accessing a bank account, entering a secure building, proceeding through a police checkpoint and/or traffic stop, renting a car, submitting an insurance claim, leaving/entering a country, etc.).

In embodiments of an identity verification process, situations where a biometric scan or personally-provided information do not match the biometric or personal information of a scanned identity document may trigger a local verification failure 433. In some embodiments, failure of a biometric match may trigger an automatic identity failure result that requires an individual be detained and their identity fully established. In other embodiments, failure of a biometric match may trigger an immediate database request 444 with either a full record search 455 or a biometric data lookup (not shown) to determine the identity of the individual that was biometrically scanned. In some embodiments, such an event may also trigger an identity theft alert 466 on the identity of the individual whose information is on the scanned identity document.

In some embodiments, an optional full record search may be available for instances where an individual passes a biometric match but does not provide personal data that matches the personal data stored on the card. Depending on the level of identity verification required and reason the identity check is being conducted, incidents such as residence address mismatch may or may not rise to the level of identity mismatch.

In the embodiment depicted, the identity verification process is self-contained based on information entirely in the possession of the individual carrying the identification document. Advantages of such a process include rapid identity validation and equally rapid detection of individuals with altered or forged identity documents. In such an embodiment, individuals whose biometric scan matches the data on their card and who provide matching personal information may quickly be identified as rightful possessors of their identity documents without requiring time-consuming database searches or other lengthy procedures. Advantages of an embodiment of such a process may therefore include minimal interruption of an individual's schedule and the ability to quickly provide reliable identification of an individual—minimizing both delays imposed on a person to be identified and load on database systems that provide comprehensive identification data when required.

Another embodiment of an identification process is depicted in FIG. 4b. The embodiment shown in FIG. 4b is directed more specifically at providing identification verification and access control through fully or partially automated security gates or checkpoints, such as ones required for border crossings, airport or railway check-in, or access to secure locations.

In the embodiment depicted, an ID document scan 400 and iris scan 411 are performed at an access gate equipped with a document reader and iris scanner. The scanning process is similar to that discussed in the preceding embodiment except that a collection of personal data may be omitted. In an alternate embodiment, however, an access gate or access point may be equipped with a user interface that can provide a challenge question based on personal information read from the identification document.

If the iris scan of the subject matches the iris scan data stored on the identification document 477, the subject has passed local verification 488. In embodiments with a personal information challenge question, the answer to the challenge question must also match the data stored on the identification document to pass local verification 488.

If a subject does not provide a matching iris scan or challenge response 477, there is a local verification failure 433 and security personnel may be notified 480. In some embodiments, a security individual may then proceed with an identity verification process similar to that discussed in the embodiment of FIG. 4a. In other embodiments, a full database search may automatically be triggered based on the iris scan 411 in the event of local verification failure 433, and the results provided along with a notification to the relevant security or response personnel.

After passing local verification, an embodiment configured for use in airports, rail stations, or border crossings may then query a travel or visa database 490 and/or a law enforcement database (not shown) to determine whether the locally authenticated subject is authorized to board the plane or train, or enter/exit the country in question. A law enforcement database search may be included in some embodiments to determine if the subject is a fugitive from a law enforcement agency in either the country being exited or the country where the subject is seeking entry.

If a locally verified subject has the necessary visa and/or travel permissions and, in embodiments configured for law enforcement search, no warrants or other flags indicating them as a fugitive or someone sought for questioning or released on bail, their visa status is flagged as ok 495. If the visa status or law enforcement status is indicated as invalid or otherwise not permitted for travel or entry, a security notification process 480 may be initiated. As mentioned above, in some embodiments, a security individual may then proceed with an identity verification process similar to that discussed in the embodiment of FIG. 4a. In other embodiments, a law enforcement database search may automatically be triggered in the event of visa verification failure 495, and the results provided along with a notification to the relevant security or response personnel.

If a locally verified subject's visa status is flagged as ok 495, in embodiments where the identification document provides passport functions, a virtual stamp 485 may be written onto a data storing portion of the identification document. Such a stamp may indicate a time, date, and location of a border crossing. In addition to a virtual stamp, a travel or visa database record may be added 425 indicating the time, date, and location of the border crossing. Such a database record may later be used to validate or verify a subject's travel history and may also be used to detect attempts at tampering with an identification document to mask or hide certain trips. A travel database record may also contain the associated travel plans of a subject, including method(s) of travel, expected duration of stay, and expected destination(s).

After a subject has been locally verified and had their visa/travel data confirmed and updated, they may be permitted to pass through a secured gate or turnstile 420 and continue with their travels. For embodiments not using automated gates, a subject may be permitted or otherwise directed by a security or border control person to proceed with entry into a building or continue with their travels.

The invention being thus described, it will be obvious that the same may be varied in many ways. Such variations are not to be regarded as departure from the spirit and scope of the invention, and all such modifications as would be obvious to one skilled in the art are intended to be included within the scope of the following claims.

1. An identity verification system, the system including:
a personally-carried identity document, said document including an image of a rightful possessor of said document, a name of the rightful possessor, a date of birth of the rightful possessor, and an address of the rightful possessor;
a data storage device included in said identity document, the storage device having stored thereon computer-readable representations of the image, name, date of birth, and address of the rightful possessor and a computer-readable representation of biometric information associated with the rightful possessor;
an identity determination unit, said unit including an identity document reader, a biometric scanner, a display, a memory portion, a user input portion, and a transceiver portion; and
a database system that includes a master database containing records of all rightful possessors of personally-carried identity documents and a biometric information database containing biometric information of all rightful possessors of personally-carried identity documents, the biometric database being associated with said master database; where the identity determination unit reads the data storage device with the identity document reader and copies the computer-readable representations from the data storage device to the memory portion;
the biometric scanner performs a biometric scan of a current possessor of the identity document and compares a result of the biometric scan to the biometric information in the memory portion; and
when the biometric scan comparison does not result in a match, the transceiver portion communicates the biometric scan data to the biometric database and receives a response from the master database that includes a record of the identity of the current possessor or a notification that the current possessor is not listed therein.

2. The system of claim 1, the user input portion being configured such that a user of the identity determination unit may manually initiate communication between the identity determination unit and the biometric database or the master database in order to retrieve data associated with a rightful possessor or a current biometric scan.

3. The system of claim 1, the system further comprising an access control gate associated with the identity determination unit and configured such that when the biometric scan comparison does not result in a match, the scanned individual is not permitted to pass through the gate.

4. The system of claim 1, where the identity document reader reads the identity document and compares the information read from the identity document to the information in the memory portion; and
when either the biometric scan comparison or the identity document comparison do not result in a match, the transceiver portion communicates the biometric scan data to the biometric database and receives a response from the master database that includes a record of the identity of the current possessor or a notification that the current possessor is not listed therein.

5. The system of claim 1, where the biometric scanner includes an iris scanner and the biometric information includes an iris scan of at least one eye.

6. An identity verification method, the method comprising:
reading a data storage device, said reading including accessing stored personal and stored biometric information associated with a rightful possessor of said device;
acquiring current personal information from a current possessor of said device;
performing a biometric scan to read current biometric information from a current possessor of said device;
determining if the current biometric information and stored biometric information match;
determining if the current personal information and the stored personal information match;
searching a biometric information database to determine the identity of the current possessor of said device based on the current biometric information when the current biometric information and stored biometric information do not match.

7. The method of claim 6, the method further comprising searching a personal information database to determine the identity of the current possessor of said device based on the current personal information when the current personal information and the stored personal information do not match.

8. The method of claim 6, the method further comprising triggering an identity theft alert for the rightful possessor in an identity database associated with said biometric information database when the current biometric information and the stored biometric information do not match.

9. The method of claim 6, the method further comprising accessing a master database and retrieving a comprehensive information record associated with the current possessor based on the determined identity of the current possessor.

10. The method of claim 6, where the stored and current biometric information are both iris scans.

11. The method of claim 6, where the personal information includes at least three of a first name, a last name, a residence address, a date of birth, and a place of birth.

12. The method of claim 6, where the data storage device is a computer-readable storage medium included as part of an identity document.

13. An identity determination unit, the unit comprising:
an iris scanner that scans at least one iris of an individual;
an identity document reader that reads a personal identity document which contains personal information printed thereon as well as a data storage device that stores personal and biometric data;
a data comparison unit that compares the iris scan of the individual against an iris scan read from the data storage device;
a display that displays the personal information read from the data storage device; a memory unit that provides local data storage capacity;
a data transmitter and receiver portion that communicates with one or more database systems, the database systems containing personal information and biometric information records associated with individuals who possess personal identity documents;
a display portion that allows an operator view information read from the personal identity document; and
an operator interface that allows a device operator to input data and commands to the determination unit.

14. The determination unit of claim 13, the unit being a man-portable unit and further including a battery pack that powers the unit; and where the data transmitter and receiver portion is a wireless communication device;
the determination unit notifies the operator of a mismatch between an iris scan acquired from scanning an individual and the iris scan stored on the data storage device; and the wireless communication device initiates communication with at least one database system after mismatch notification in order to determine the actual identity of the scanned individual; and
the operator interface allows the operator to manually initiate communication with at least one database system and input search criteria acquired from the iris scan, the data storage device, or through manual operator input.

15. The determination unit of claim 13, the unit being integrated into an access control device that does not per pit an individual to pass through a gate of the access control device unless the iris scan of the individual matches the iris scan stored on the data storage device.

16. The determination unit of claim 15, where the access control device does not permit an individual to pass through the gate unless access authorization information read from the data storage device indicate that the individual is authorized to pass through the gate.

17. The determination unit of claim 15, where access authorization information includes at least one of: citizenship, visa status, visa history, security clearance, organization identification number, and taxpayer identification number.

18. (canceled)

19. The determination unit of claim 13, where the data transmitter and receiver portion includes a data encryption/decryption sub-unit that encrypts data before transmission and decodes received encrypted data.

20. The determination unit of claim 14, where the operator interface displays the results of the actual identity determination to inform the operator of the real identity of the scanned individual.

21. (canceled)

22. (canceled)

23. (canceled)

24. (canceled)

25. (canceled)
